(19) United States
(12) Patent Application Publication
(10) Pub. No.: US 2025/0221348 A1
(43) Pub. Date: Jul. 10, 2025

(54) SCALABLE SELF-WATERING PLANTER SYSTEM AND METHOD THEREOF

(71) Applicant: Quang Hong Kao, Richmond Hill (CA)

(72) Inventor: Quang Hong Kao, Richmond Hill (CA)

(21) Appl. No.: 18/406,043

(22) Filed: Jan. 5, 2024

(51) Int. Cl. A01G 27/00; A01G 9/24

(52) U.S. Cl. CPC A01G 27/005; A01G 9/247; A01G 27/008

(57) ABSTRACT

A scalable self-watering planter system includes water reservoir 102 connected to transparent tank 104 via a first pipe 106, allowing visual monitoring of water levels. The tank's water level is managed by a float valve 108. Connected to this tank is a modular planter system through a second pipe. Each module 110 comprises a soil compartment 202 with a protruding section 204 containing multiple holes 206 at its base. The bottom of the soil compartment contained multiple holes 306 at its base. The interior of the soil compartment is lined with a water-permeable garden cloth 222, facilitating even moisture distribution and soil retention. Positioned beneath the soil compartment is a water compartment 208, where the protruding section makes contact. Between the soil and water compartments, an air layer is established, promoting oxygen supply to plant roots. The system optimizes water use, ensures consistent plant hydration, and simplifies maintenance tasks.

### FIELD OF INVENTION

The present invention relates to gardening and plant cultivation systems. Specifically, it pertains to a scalable self-watering planter system designed to save gardener's time in providing consistent water and oxygen supply to plants, particularly suited for urban environments with limited traditional gardening space.

### BACKGROUND OF THE INVENTION

As society continues to urbanize, the importance of green spaces and gardening within urban environments has become increasingly prominent. While urban dwellers have always sought to integrate nature into their homes, often by cultivating potted plants on windowsills, balconies, or in small terrace gardens, this need has become even more pronounced with the constraints of modern urban life.

One of the primary constraints is space. The rising cost of real estate and the move towards apartment living means that large gardens are a luxury many cannot afford. Within these constraints, gardening enthusiasts are constantly on the lookout for ways to maximize their gardening space while maintaining the health and well-being of their plants.

Another significant challenge faced by urban gardeners is the amount of time needed to ensure their plants receive the appropriate amount of water. Many plants need a minimum of once-a-day watering. Inconsistencies in watering either too much or too little can lead to a myriad of plant health problems. The fast-paced life of the modern urbanite means that plants often do not get the consistent care they require. Whether it's forgetting to water them, over-watering, or not having a system in place to care for them during extended absences, maintaining optimal moisture levels for plants in an urban setting is a daunting and time consuming task which deter many would be gardeners.

Recognizing these problems, several self-watering systems have been introduced. The premise behind these systems is simple: allow plants to draw the exact amount of water they need, when they need it. However, while these systems have made strides in easing the burden of plant care, they come with their own set of challenges.

First and foremost is the issue of scalability. Many of the existing self-watering systems are designed for individual pots or a small number of plants. As such, they do not lend themselves well to gardeners who might want to scale up their operations or manage multiple plants with varying water requirements.

Then there is the matter of oxygen. Any seasoned gardener will attest to the importance of ensuring that plant roots receive adequate oxygen. Plant roots require oxygen for respiration. Without sufficient oxygen, root cells would undergo anaerobic respiration, which is less efficient and can lead to accumulation of toxic by-products. Good oxygen supply to the roots ensure healthy root growth and overall plant vitality. The balance between water and oxygen is delicate, and many existing self-watering systems struggle to get it right. Prior patents have made significant attempts to address these issues.

U.S. Pat. No. 9,241,452B2 stands out with its innovative multi-elevation system. It incorporates a primary container and several secondary containers placed at different elevations, interconnected via tubes. This system, while ingenious in its design, seems focused on ensuring consistent dry-down times across its various containers. However, the rigidity of its design may not be ideal for all plant types, particularly those with unique watering requirements.

US20140007501A1 takes a different approach by emphasizing the maintenance of a consistent water level across a wick. The design hinges on a vacuum seal, ensuring that the soil has access to water consistently. However, questions arise about the versatility of this system. Does it adapt well to larger gardens? Can it cater to the varied water needs of different plants?

U.S. Pat. No. 6,079,156A presents another innovative solution, with a self-watering assembly compatible with conventional planters. Its reliance on spandex as a capillary material is particularly intriguing, potentially offering a more efficient water distribution system. However, its adaptability across different plant types, sizes, and environments remains a question.

All these prior art systems have their merits, but gaps still exist. For instance, modularity seems to be an overlooked aspect in many designs. Urban gardeners often have to rearrange or expand their gardens, and a system that could easily adapt to these changing needs would be invaluable.

Furthermore, while some systems do touch upon the importance of oxygen for roots, there appears to be a lack of comprehensive solutions that consider both consistent water supply and adequate aeration.

Another area of potential improvement is customization. Every plant species has its own unique water requirements, and a one-size-fits-all approach may not always yield the best results. Systems that allow for customization based on individual plant needs could revolutionize urban gardening.

In summary, while the quest for the perfect urban gardening solution has seen numerous innovative approaches, a comprehensive system that ticks all the boxes-minimum time needed for maintenance, scalability, efficient water management, adequate aeration, modularity, and customization remains elusive. The present invention seeks to address these challenges, aspiring to bring the joy of hassle-free gardening to urban dwellers everywhere.

### SUMMARY OF THE INVENTION

In light of the disadvantages mentioned in the previous section, the following summary is provided to facilitate an understanding of some of the innovative features unique to the present invention and is not intended to be a full description. A full appreciation of the various aspects of the invention can be gained by taking the entire specification and drawings as a whole.

The present invention introduces a scalable self-watering planter system specifically tailored for urban environments, seamlessly merging modularity, efficient water management, and enhanced aeration. Central to the system is a dedicated water reservoir which seamlessly connects to a transparent tank through a first pipe, enabling users to effortlessly monitor water levels and ensuring optimal hydration for plants. This is further complemented by a float valve mechanism which ensures consistent water levels within the transparent tank. A distinctive feature is the modular planter system, interconnected with the transparent tank. Each module boasts a soil compartment with a unique protruding section lined with a water-permeable garden cloth. Directly beneath lies a water compartment where the protruding soil section imbibes water, employing capillary action wet the soil in the rest of the planter starting from bottom up. Additionally, an innovative air layer between the soil and water compartments ensures roots have access to both water and essential oxygen.

To further enhance its utility, the invention incorporates a rainwater collection mechanism, offering an eco-friendly means to supplement the system's water supply. The system can be connected to a running water source for a totally intervention free self-watering system. Recognizing the diverse hydration needs of various plants, some embodiments also feature an adaptor to modify the size or shape of the soil compartment's protruding section. This allows for tailored water-wicking, accommodating different plant species. In its entirety, this invention revolutionizes urban gardening by ensuring plant health, minimizing water wastage, and delivering a user-centric experience. Most importantly, it saves a lot of gardeners' time in ensuring that plants receive appropriate amount of water to thrive.

This summary is provided merely for purposes of summarizing some example embodiments, to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following detailed description and figures.

The abovementioned embodiments and further variations of the proposed invention are discussed further in the detailed description.

### BRIEF DESCRIPTION OF THE DRAWINGS

FIG. 1 is an exemplary illustration 100 of the scalable self-watering planter system according to the embodiments of the present disclosure.

FIG. 2A is an exemplary illustration 200A of the soil compartment and the water compartment of each module of the modular planter system according to the embodiments of the present disclosure.

FIG. 2B is an exemplary illustration 200B of the soil compartment and the water compartment of each module of the modular planter system, fitted together, according to the embodiments of the present disclosure.

FIG. 3 is a top view 300 of the soil compartment according to the embodiments of the present disclosure.

FIG. 4 is a bottom perspective view 400 of the soil compartment according to the embodiments of the present disclosure.

FIG. 5 is a cross sectional view 500 of a module of the modular planter system according to the embodiments of the present disclosure.

FIG. 6A is an exemplary illustration 600A of the scalable self-watering planter system's built-in feature to collect rainwater in passive mode according to the embodiments of the present disclosure.

FIG. 6B is an exemplary illustration 600B of the scalable self-watering planter system's built-in feature to collect rainwater in passive mode in operation according to the embodiments of the present disclosure.

FIG. 7A is an exemplary illustration 700A of the scalable self-watering planter system configured to collect rainwater in active mode according to the embodiments of the present disclosure.

FIG. 7B is an exemplary illustration 700B of the scalable self-watering planter system configured to collect rainwater in active mode in operation according to the embodiments of the present disclosure.

FIG. 8 is an exemplary illustration 800 of the scalable self-water planter system configured to connect to running water according to the embodiments of the present disclosure.

### DETAILED DESCRIPTION

In the following description of the embodiments of the invention, reference is made to the accompanying drawings that form a part hereof, and in which are shown by way of illustration specific embodiments in which the invention may be practiced. These embodiments are described in sufficient detail to enable those skilled in the art to practice the invention, and it is to be understood that other embodiments may be utilized and that changes may be made without departing from the scope of the present invention. The following detailed description is, therefore, not to be taken in a limited sense, and the scope of the present invention is defined only by the appended claims.

The specification may refer to “an”, “one” or “some” embodiment(s) in several locations. This does not necessarily imply that each such reference is to the same embodiment(s), or that the feature only applies to a single embodiment. Single feature of different embodiments may also be combined to provide other embodiments.

As used herein, the singular forms “a”, “an” and “the” are intended to include the plural forms as well, unless expressly stated otherwise. It will be further understood that the terms “includes”, “comprises”, “including” and/or “comprising” when used in this specification, specify the presence of stated features, integers, steps, operations, elements and/or components, but do not preclude the presence or addition of one or more other features integers, steps, operations, elements, components, and/or groups thereof. As used herein, the term “and/or” includes any and all combinations and arrangements of one or more of the associated listed items.

Unless otherwise defined, all terms (including technical and scientific terms) used herein have the same meaning as commonly understood by one of ordinary skill in the art to which this disclosure pertains. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

In the present disclosure, a comprehensive self-watering planter system is unveiled, which offers a blend of functionality, versatility, and efficiency. Unlike conventional planter systems that often demand constant manual watering and maintenance, the invention, as described, integrates unique mechanisms and configurations that autonomously ensure optimal moisture conditions for various plants.

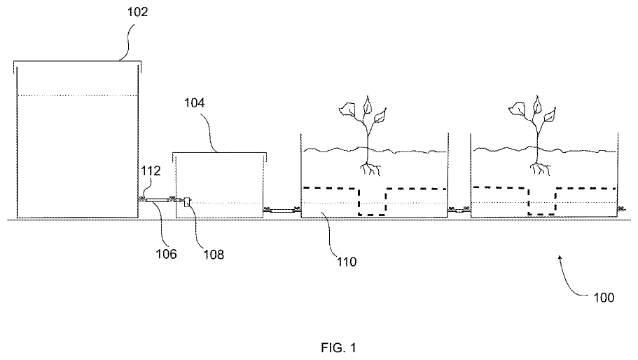

FIG. 1 illustrates an exemplary configuration of the scalable self-watering planter system. Central to this system is the water reservoir 102, a primary storage unit for water. This reservoir is fluidly connected to the transparent tank 104 via the first pipe 106 wherein water flow maybe controlled by an ON/OFF valve 112. The transparent tank is particularly significant as it allows gardeners to visually monitor water levels, ensuring timely refills and eliminating guesswork.

A key component ensuring a consistent water level within the transparent tank is the float valve 108. The float valve is activated when the water level in the transparent tank falls below a predetermined level, resulting in the opening of the valve and the release of water from the reservoir into the transparent tank.

Interconnected to the transparent tank through a second pipe is the modular planter system 110, the heart of this invention. This system's modular nature implies it can be scaled up or down by adding or removing a planter depending on spatial requirements and the number of plants intended for cultivation. The water from the transparent tank flows into the planter until the water level in both the transparent tank and the planter reach an equilibrium level when the float valve shuts off. By regulating the flow of water between the water reservoir and the transparent tank, the float valve guarantees that plants in the planter system receive an uninterrupted supply of water, even during periods when the gardener might be away, as long as there is sufficient water remaining in the water reservoir. While FIG. 1 illustrates two planter modules being interconnected in the system, the modular nature of this invention allows multiple planter modules to be interconnected and share water from the same transparent tank and reservoir.

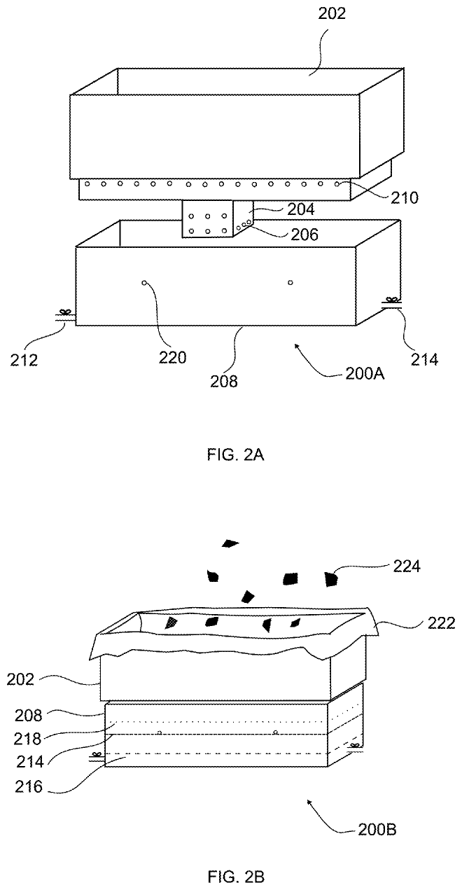

FIG. 2A provides an insightful depiction of the components housed within each module of the modular planter system. A critical section is the soil compartment 202 where plants are grown. This compartment is innovatively designed with a protruding section 204 at its base, which houses a plurality of holes 206. These holes, while seemingly simple, play a pivotal role in the self-watering mechanism. They allow water to be drawn upwards by the soil acting as a natural wick, ensuring that plant roots always have access to moisture without being waterlogged. Furthermore, holes 210 are provided for allowing aeration into the soil along the bottom side and bottom of the soil compartment.

ON/OFF valves 212 and 214 are provided on each side of the planter for controlling the flow of water in and out of the planter, useful during system maintenance or adjustment. The valves are also used to drain water from the planter when the planter needs to be moved.

Below the soil compartment is the water compartment 208. This compartment receives water from the transparent tank, storing it directly beneath the soil compartment. The unique positioning ensures that the protruding section of the soil compartment, laden with moisture-wicking holes, remains in constant contact with the stored water. The soil and water compartments may be separable or fixed in nature depending upon the requirements of the user. Overflow holes 220 in the water compartment ensure that water do not fill above this level and drown the plants. These holes also allow air to come into contact with the bottom section of the soil compartment.

FIG. 2B depicts the modular planter system as it is assembled and ready to use. As can be seen, the soil compartment 202 is fitted snuggly on top of the water compartment 208. The garden cloth 222 is fitted inside the soil compartment and the soil 224 is added on top of the garden cloth. Dotted line 218 indicates the bottom level of the soil compartment that is outside the protruding section. Line 214 indicates the highest level that water can be filled to in the water compartment. Above this level, the water will be drained through the overflow holes 220. The layer between 214 and 218 is the air layer which is important for supplying aeration to the soil. This is a unique feature of this invention and allows the roots of the plant to get enough oxygen. Line 216 indicates the level of water below which the float valve in the transparent tank will be triggered and release more water. Between the lines 214 and 216 is the space that can store rainwater passively. This passive rainwater collection capability is built into the system's features.

The water-permeable garden cloth 222 is lined along the bottom and side of the soil compartment 202 for blocking soil from leaking through the plurality of holes. This specialized cloth is strategically positioned to serve multiple essential roles:

Soil Retention: One of the primary functions of this cloth is to prevent the soil from seeping into the water compartment 208 and clog the pipes. By doing so, it ensures that the water in the compartment remains clear of debris, facilitating a clean and efficient wicking action through the protruding section 204 and preventing the clogging of pipes between planters.

Enhanced Wicking Action: While the cloth is designed to retain soil, its permeable nature is instrumental in allowing water to seep through. When the water rises from the water compartment, the cloth assists in distributing the moisture more evenly throughout the soil compartment. This ensures that the entire volume of soil benefits from the hydration process, providing a more uniform moisture level for the plant's roots.

Root Protection: The cloth serves as a protective barrier for the plant's roots. By preventing the roots from directly accessing the water compartment, it ensures that the plants do not become waterlogged or overly saturated in water, which could lead to root rot or other plant diseases.

Easy Maintenance: The incorporation of the water-permeable cloth also simplifies maintenance tasks. When it is time to replace or refresh the soil, the cloth can easily be lifted, making soil removal and replacement straightforward and mess-free. This design feature ensures longevity and ease of use of the system, allowing even novice gardeners to maintain their plants with ease.

Adaptability: The design allows for the cloth to be replaced or interchanged depending on the type of plant or specific needs. Certain plants might require a cloth with a different permeability rate, and this system's design ensures that such customizations can be made without overhauling the entire module.

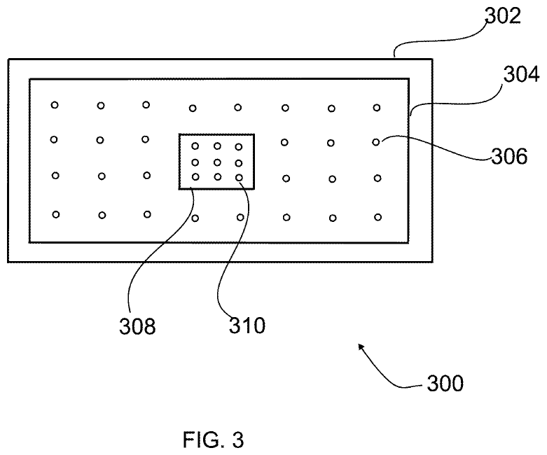

FIG. 3 illustrates a top view 300 of the soil compartment according to the embodiments of the present disclosure. The soil compartment has wider top section 302 and slightly smaller bottom section 304. Plurality of holes 306 lined the bottom wall of the soil compartment to allow for aeration of the roots of plants. The protruding section 308 of the soil compartment have plurality of holes 310 at the bottom to facilitate water wicking.

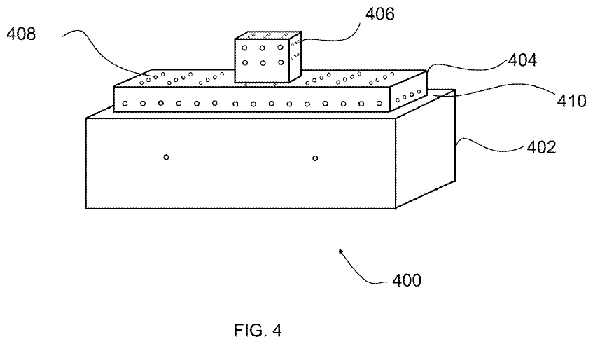

FIG. 4 offers a bottom perspective, granting viewers an understanding of how various components, especially the protruding sections, are positioned and interlinked. This perspective underscores the system's ergonomic design, optimized for snug fitting into the water compartment, efficient water flow, aeration of roots, as well as for the ease of removal of soil compartment from the water compartment during maintenance. Protruding section 406 has a plurality of holes for water wicking. Bottom section 404 is slightly smaller than the top section 402 forming an indentation 410 which is intended to rest on top of the upper frame of the water compartment. Plurality of holes 408 are crucial for the aeration of the soil and thus the roots of the plants.

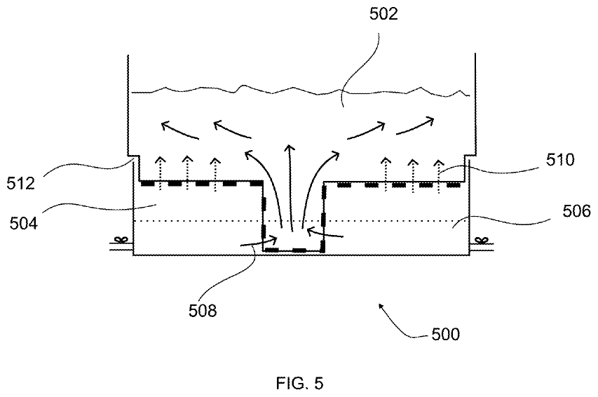

FIG. 5, a cross-sectional representation, illuminates the critical concepts behind the invention. It vividly displays the spatial arrangement between the soil and water compartments, the air layer ensuring oxygenation, and the nuances of the water and air flow through the system. As understood by a person skilled in the art, the area marked as 502 comprises soil, 504 comprises air, and 506 comprises water. The solid arrows 508 indicate the movement of water that flows through the holes into the protruding section of the soil compartment, then up the remainder of the soil compartment through capillary action. The dashed arrows 510 indicate the movement of air from the air layer into the soil compartment. An indentation in the outer wall of the soil compartment 512 rests on top of the wall of the water compartment, distributing some of the weight of the soil compartment from the protruding section, contributing to the durability of the entire soil compartment.

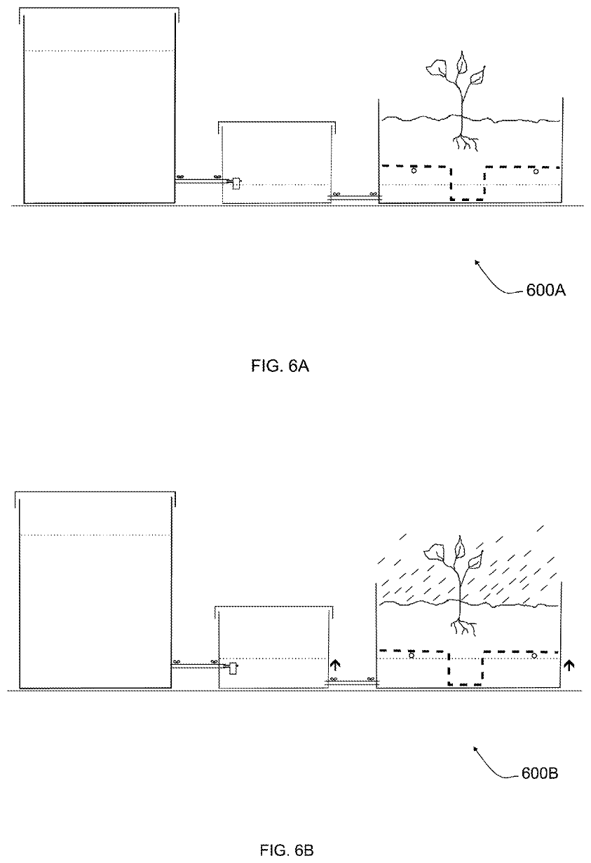

FIG. 6A is an exemplary illustration 600A of the scalable self-watering planter system built-in feature to collect rainwater in passive mode. FIG. 6B is an exemplary illustration 600B of the scalable self-watering planter system built-in feature to collect rainwater in passive mode in operation. Accordingly, as illustrated in FIG. 6B, the planter system collects water when it rains and distribute these into the water compartment 208 and the transparent tank 104. As illustrated in the description of FIG. 2B, a certain amount of rainwater is collected while excess water escapes through the overflow holes 220 prevents drowning of plants. Additionally, rainwater from eave troughs can be directed via a pipe into the reservoir 102 for increased collection.

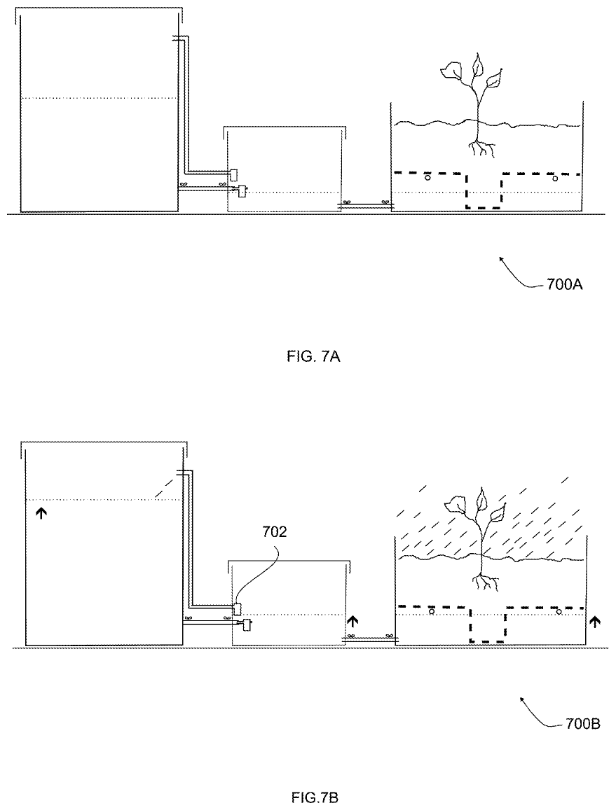

FIG. 7A is an exemplary illustration 700A of the scalable self-watering planter system configured to collect rainwater in active mode. FIG. 7B is an exemplary illustration 700B of the scalable self-watering planter system configured to collect rainwater in active mode in operation. Accordingly, as illustrated in FIG. 7B, the planter system collects water when it rains and distribute these into the water compartment 208 and the transparent tank 104. Furthermore, a pumping mechanism 702 is provided to pump water from the transparent tank to the water reservoir 102. The pump gets activated when the water level reaches above a certain level allowing water to be transferred from the transparent tank to the water reservoir. The pump may be powered by conventional means such as electricity or via a solar powered solution as preferred by the user. This set up is useful especially when there are many planter modules away from other rainwater collecting means such as a roof.

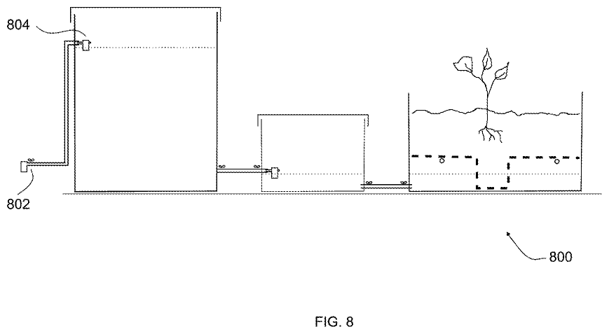

FIG. 8 is an exemplary illustration 800 of the scalable self-watering planter system configured to connect to running water. This configuration allows for extensive period where the gardener can be away without worrying about watering. The crucial part of this configuration is the source of running water 802 which is connected to the water reservoir 102 by a pipe. This pipe is connected to a supply float valve 804 which is placed inside the water reservoir. When the water level inside the reservoir falls below a certain designated level, the supply float valve is triggered and release water into the reservoir until the water level is back at that specific level where the float valve shuts off. As long as there are running water, this set up will allow the system to be completely independent of the gardener in terms of water management. This set up will free the gardener to be away for extended periods of time, as in the case of a long vacation.

The scalable self-watering planter system introduces a plethora of advantages:
Scalability: Gardeners can customize the system size based on space and plant requirements. This is possible due to the modular design of the system thereby allowing adding of additional planter modules to the system with ease.
Efficiency/Sustainability: The self-watering mechanism reduces water wastage and ensures plants receive optimal moisture levels.
Transparency: The transparent tank eliminates guesswork, allowing for easy water level monitoring.
Versatility: The modular design caters to both indoor and outdoor gardening endeavors.
Autonomy: The system's integrated components reduce the need for constant manual intervention.

While the invention has been described in its preferred form, it is important to note that numerous variations are possible without deviating from its core essence.

The shape and design of the water reservoir, transparent tank, and modular planter system can be altered to better suit aesthetic preferences or spatial constraints. The transparent tank may be substituted with a partially transparent or a non-transparent one, and the reservoir may be made to be partially transparent or transparent, while still allowing for quick visualization of when the system needs more water. Different materials might be employed for constructing the system, provided they remain conducive to plant growth and water storage. Advanced mechanisms, like sensors for moisture level detection or automated refill systems, can be integrated for enhanced functionality.

By offering scalability, versatility, and a sustainable approach to gardening, this self-watering planter system revolutionizes how we perceive and engage with urban gardening. Its thoughtful design and intricate components cater to both novice gardeners and seasoned horticulturists, marking a significant stride in sustainable urban agriculture.

Central to the efficiency of the scalable self-watering planter system is its underlying mechanism. While many traditional systems rely on gravity or direct immersion, this invention ensures that the roots have access to water without being submerged constantly, reducing risks of root rot and other common plant ailments.

The equilibrium between hydration and aeration results from the intricate balance between the soil compartment 202 and the water compartment 208. The protruding section 204 of the soil compartment, with its plurality of holes 206, ensures that water is capillarity drawn upwards mimicking nature's way of providing moisture to plants. The beauty of this mechanism is that the plant draws water only when required, ensuring that it neither drowns in excess moisture nor starves due to lack thereof. As the plant uses up water in the planter, water from the transparent tank flows in to replace them. As the level of water in the transparent tank drops below a certain level 216, the float valve gets activated, resulting in the flow of water from the reservoir until the level in the transparent tank is back again at 216 level, when the float valve shuts off.

Beyond just watering, the scalable self-watering planter system has been designed to cater to the holistic needs of plants. The gap between the soil compartment and the water compartment guarantees aeration, an often-neglected aspect of plant care. Roots, just like the rest of the plant, require oxygen to thrive. By ensuring that roots have access to an oxygen-rich environment, the system fosters enhanced growth, root strength, and overall plant health.

The modular nature of the planter system does not merely cater to functional requirements. In an age where aesthetics and functionality go hand in hand, the system's design can seamlessly blend with modern home and garden decors. Be it the sleek transparent tank that adds a touch of modernity or the modular planters that can be rearranged to match evolving design sensibilities, this invention integrates horticulture with aesthetics.

In an era where sustainability is paramount, the scalable self-watering planter system presents a step in the right direction. By optimizing water usage and reducing wastage, the invention aligns with global efforts to conserve water. Further, by enabling urban dwellers to cultivate plants efficiently, it aids in improving air quality and fostering green spaces in concrete jungles.

As with all inventions, the scalable self-watering planter system holds potential for future enhancements. Possibilities include integrating IoT devices for remote monitoring and control, adding nutrient dispensing systems for holistic plant care, or even incorporating solar-powered mechanisms to further its sustainability quotient.

Rainwater Collection Mechanism: The scalable self-watering planter system is designed to be environmentally sustainable by integrating a rainwater collection mechanism. This mechanism is strategically positioned to collect rainwater from the surroundings. Once collected, the water passes through a filtration system that ensures the removal of large debris, contaminants, or particles that could potentially clog the system or harm the plants. After filtration, the water is directed into the water reservoir 102. The inclusion of this rainwater collection component not only promotes sustainability but also reduces the reliance on manually filling the reservoir and ensures that plants have access to a natural water source. This harvested rainwater is rich in essential minerals, which can be beneficial for the growth and health of plants.

Adjustable Protruding Section with Adaptor: The system can be equipped with an innovative adaptor that can be fitted to the protruding section 204 of the soil compartment (202). This adaptor is specifically designed to cater to different plant types which may have varied water wicking requirements. It is constructed from a durable material that allows it to be adjusted in size and shape. Depending on the hydration needs of a particular plant, the user can either increase or decrease the size of the protruding section. By doing so, the amount of soil that comes into direct contact with the water in the water compartment (208) can be controlled, thus regulating the wicking action. This adaptable feature ensures that whether the plant requires more or less water, the system can be adjusted accordingly to provide optimal hydration conditions. Furthermore, the adaptors come in various configurations to accommodate different soil types, plant sizes, and growth stages.

Level Adjusters: The system may be equipped with level adjusters that can be placed under the transparent tank or the modular planters so that their horizontal level can be adjusted to match each other. This is helpful in the situation where the horizontal surface is not flat but sloping.

Structured Method for Consistent Watering: The present invention proposes a systematic method to ensure plants receive consistent and optimal watering:

Water Storage: The first step involves storing water, either manually filled or collected via the rainwater collection mechanism, or from running water source, in the water reservoir 102.

Transfer and Regulation: Using the first pipe 106, water is transferred from the water reservoir to the transparent tank 104. The transparent nature of the tank allows users to visually inspect and monitor water levels. The float valve 108 is pivotal at this juncture as it regulates the water level within the transparent tank, ensuring that it does not fall below a certain level.

Plant Module Watering: The modular planter system 110 is then interconnected to the transparent tank via a second pipe. Here, the water flows into the water compartment 208 of each module. The innovative design of the soil compartment, particularly the protruding section 204 with its holes 206, allows the soil to act as a wick. This wicking action draws water upwards, ensuring that the soil remains moist, providing an ideal environment for the plants.

Oxygen Supply: An integral aspect of this system is the air layer between the soil and water compartments. This air layer ensures that while the soil remains moist, it is not waterlogged, promoting the supply of oxygen to the plant roots, which is crucial for their growth and health.

Adjustments for Plant Types: Depending on the specific hydration needs of the plant, the adaptor can be utilized to adjust the protruding section's size or shape, ensuring the right amount of water wicking action.

By following this systematic procedure, the present invention ensures that plants receive the right amount of water, promoting their growth and health, while also conserving water and being environmentally sustainable.

Through its blend of design, functionality, and sustainability, the scalable self-watering planter system transforms how we perceive and interact with urban gardening spaces. Its potential extends beyond mere plant care, impacting urban design, sustainability efforts, and even the broader ambit of environmental conservation.

It may be noted that the above-described examples of the present solution are for the purpose of illustration only. Although the solution has been described in conjunction with a specific embodiment thereof, numerous modifications may be possible without materially departing from the teachings and advantages of the subject matter described herein. Other substitutions, modifications and changes may be made without departing from the spirit of the present solution. All the features disclosed in this specification (including any accompanying claims, abstract and drawings), and/or all of the steps of any method or process so disclosed, may be combined in any combination, except combinations where at least some of such features and/or steps are mutually exclusive.

The terms “include,” “have,” and variations thereof, as used herein, have the same meaning as the term “comprise” or appropriate variation thereof. Furthermore, the term “based on”, as used herein, means “based at least in part on.” Thus, a feature that is described as based on some stimulus can be based on the stimulus or a combination of stimuli including the stimulus.

The present description has been shown and described with reference to the foregoing examples. It is understood, however, that other forms, details, and examples can be made without departing from the spirit and scope of the present subject matter.

1. A scalable self-watering planter system comprising:
a water reservoir for storing water;
a transparent tank connected to said water reservoir via a first pipe, wherein said transparent tank allows for visual inspection of water levels;
a float valve configured to control the water level within the transparent tank; and
a modular planter system interconnected with the transparent tank via a second pipe, each module of said planter system comprising:
a soil compartment having a plurality of holes at its bottom and a protruding section, wherein the protruding section comprises a plurality of holes at its bottom;
a water compartment disposed below said soil compartment, wherein the protruding section of the soil compartment is adapted to be in contact with water from said transparent tank stored in said water compartment, wherein the water compartment comprises overflow holes for disposing excess water; and
an air layer established between the soil compartment and the water compartment, promoting oxygen supply to plant roots.

2. The scalable self-watering planter system of claim 1, wherein the interior portion of the soil compartment is covered using a water permeable garden cloth.

3. The scalable self-watering planter system of claim 1, further comprising an active or passive rainwater collection mechanism adapted to direct and store collected rainwater into said water reservoir, thereby supplementing the water supply for the system.

4. The scalable self-watering planter system of claim 1, wherein the water from said reservoir refills said transparent tank based on the level controlled by said float valve.

5. The scalable self-watering planter system of claim 1, wherein the soil within the protruding section acts as a wicking mechanism to draw water upward from the water compartment to moisten the soil in the soil compartment.

6. The scalable self-watering planter system of claim 1, wherein said water reservoir, transparent tank, and the one or more planter modules are interconnected to facilitate a continuous supply of water to said planter system.

7. The scalable self-watering planter system of claim 1, further comprising an adaptor configured to adjust the size or shape of said protruding section, allowing for varied water wicking depending on the type of plant being grown.

8. The scalable self-watering planter system of claim 1, wherein said water reservoir houses a supply float valve that is connected to a source of running water, allowing for constant supply of water to the planter system.

9. A method for providing consistent watering to plants using a scalable self-watering planter system, the method comprising the steps of:
storing water in a water reservoir;
transferring water from the water reservoir to a transparent tank via a first pipe, wherein said transparent tank facilitates visual inspection of water levels;
regulating the water level within the transparent tank using a float valve;
connecting a modular planter system to the transparent tank via a second pipe;
positioning a soil compartment within each module of the planter system, said soil compartment having a protruding section at its bottom with a plurality of holes;
positioning a water compartment below the soil compartment such that the protruding section of the soil compartment contacts water transferred from the transparent tank to the water compartment;
positioning overflow holes in the water compartment for disposing excess water; and
establishing an air layer between the soil compartment and the water compartment, thereby promoting oxygen supply to plant roots.

10. The method of claim 9, further comprising steps:
lining the interior portion of the soil compartment with a water-permeable garden cloth.

11. The method of claim 9, further comprising the step of:
collecting rainwater using an integrated rainwater collection mechanism and storing the collected rainwater into the water reservoir, supplementing the water supply for the system.

12. The method of claim 9, further comprising the step of:
utilizing the soil within the protruding section as a wick to elevate water from the water compartment and humidify the soil.

13. The method of claim 9, further comprising the step of:
ensuring a continuous water supply by interconnecting the water reservoir, transparent tank, and planter modules.

14. The method of claim 9, further comprising the step of:
modifying the water wicking capability by adjusting the protruding section's size or shape using an adaptor, catering to the specific hydration needs of varied plant types.

15. The method of claim 9, wherein said water reservoir houses a supply float valve that is connected to a source of running water, allowing for constant supply of water to the planter system.
